(19) United States
(12) Patent Application Publication
(10) Pub. No.: US 2017/0253519 A1
(43) Pub. Date: Sep. 7, 2017

(54) GUTTER SYSTEM FOR AN IS MACHINE

(71) Applicant: HEYE INTERNATIONAL GMBH

(72) Inventors: Benedikt FELGENHAUER, Herford (DE); Jonas ULBRICHT, Hessisch Oldendorf (DE); Eckhard MÖLLER, Obernkirchen (DE); Thorben NAUDIETH, Stadthagen (DE)

(21) Appl. No.: 15/315,589

(22) PCT Filed: May 30, 2015
(86) PCT No.: PCT/EP2015/001099

§ 371 Date: Jan. 27, 2017

(30) Foreign Application Priority Data
Jun. 5, 2014 (DE) 102014008006.4

(51) Int. Cl. C03B 7/16

(52) U.S. Cl. CPC C03B 7/16

(57) ABSTRACT

The problem addressed by the invention is that of simplifying a conversion of the gutter system of an IS machine, for example, from double forming operation to triple forming operation and vice versa. This problem is solved in that a guide plate assembly (80) is provided in the course of the sliding path for molten glass drops, which guide plate assembly consists of a first assembly, which is composed of an elongate base (26) intended to be fastened to a scoop beam (21) and of supporting segments (29, 30) attached to said base, and a second assembly, which is composed of a guide plate unit (22) designed as a direct support of guide plates (42) and intended to be mounted on the first assembly. A conversion in the aforementioned sense can be limited to a replacement of said second assembly, whereby a significant reduction in assembly activities and set-up activities can be achieved.

The invention pertains to a gutter system according to the preamble of claim 1.

Such a gutter system is intended for transferring the molten glass composition in the form of gobs, which are produced by dividing a strand and exit a gob feeder, into a mould, namely the blank mould of an IS machine, in which the actual glass forming process begins. The gutter system consists of at least one scoop gutter mounted rotatably about a vertical axis, a sliding system or guide plates featuring several gutter-like sliding members, a number of troughs corresponding to the number of sliding members and respective chutes, which are arranged adjacent to a trough and intended for centrally introducing a glass gob into a blank mould. The number of sliding members, troughs and chutes corresponds to the number of stations multiplied by the number of cavities of the IS machine, wherein the glass gobs being formed are successively transferred onto the different sliding systems by rotating the scoop gutter.

The gutter system may be designed, for example, for a single-gob operation, in which only one blank mould is loaded in each of the stations of the IS machine. However, it may also be designed for a double-gob or triple-gob operation, in which two or three corresponding blank moulds have to be loaded in each of the stations. In the two latter instances, the gob feeder loads two or three scoop gutters, the respective sliding paths of which lead into the sliding members of two or three sliding systems or guide plates that are arranged on top of one another in an offset fashion, wherein the glass gobs are subsequently transferred into the respectively assigned blank mould by means of a corresponding number of troughs and chutes.

The scoop gutter/scoop gutters is/are rotatable about a respective vertical axis, but in other respects fixed on the machine. The sliding systems are respectively mounted on horizontally extending arms of a console, which are in turn carried by a scoop beam fixed on the machine. The troughs are mounted on the respective sliding systems in a horizontally and vertically adjustable fashion with their upper ends, i.e. their ends that face the sliding members, wherein their respective lower ends are held such that they can be adjusted relative to the facing ends of the chutes. The chutes are ultimately held on a console fixed on the machine by means of vertical and horizontal adjusting devices. Consequently, several adjustment options are provided in order to ensure a continuity of the sliding paths, a superelevation of the sliding path section of the scoop gutter relative to the following sliding member, as well as of the sliding path section of the sliding member relative to the trough and ultimately the chutes, and to thereby centrally introduce the glass gobs into the blank mould. These adjustment options are constructively realized in the form of screw joints, some of which are guided in oblong holes, spherical head mountings and threaded spindles in connection with chain gears. The availability of a certain sliding path for the glass gobs, which is defined by components adjusted relative to one another, is of vital importance for a reproducible work result.

In order to improve the cost-effectiveness, it is occasionally required to retrofit an IS machine designed for a single-gob operation such that it can operate in a double-gob or even triple-gob mode. However, this option is only rarely utilized due to the associated labor input, particularly the time required for the retrofitting process and the associated downtime of the machine. Such a conversion respectively requires the removal and exchange of the console carrying the chute adjusting devices, as well as the console carrying the arms intended for supporting the sliding system/s, wherein the installation is associated with extensive adjustments in order to configure a defined sliding path for the glass gobs.

A gutter system of this type is known, for example, from EP 0 654 451 B1.

Another a gutter system is known from DE 295 08 465 U1. In this case, no trough is used such that the chute/chutes are arranged directly adjacent to the sliding system/s. In comparison with EP 0 654 451, the mounting of the chutes is additionally characterized by a height adjustment realized with the aid of a spindle gear, wherein the sliding systems are once again fixed on a scoop beam by means of the arms of a console. The connection between the lower ends of the sliding system and the facing upper ends of the chutes is also adjustable, particularly with respect to a superelevation.

However, the retrofitting work associated with a conversion, for example, from a single-gob operation to a multi-gob operation is also highly complex in this case.

The invention is based on the objective of improving a gutter system of the initially cited type with respect to the simplification of the retrofitting work associated with a conversion from a single-gob operation to a multi-gob operation and vice versa. In such a gutter system, this objective is attained with the characteristics disclosed in the characterizing portion of claim 1.

It is accordingly essential to the invention that the guide plate assembly is divided into a first subassembly, which is directly mounted on the machine frame, and a second subassembly designed as carrier of the guide plates. The first of these two subassemblies is fixed on the machine frame in a defined position, which is determined by the sliding paths for molten glass gobs to be realized, and simultaneously serves for realizing a standardized coupling or insertion position for the second subassembly. This starting position allows a simple conversion, for example, from a double-mould operation to a triple-mould operation and vice versa by simply removing and exchanging the second of the two subassemblies, wherein such a replacement can be realized because the first subassembly is designed for cooperating with different second subassemblies. This means that the first of the two subassemblies always remains on the machine frame in unchanged form during such a conversion. When the machine is converted, for example, from a double-gob operation to a triple-gob operation, a guide plate is removed and two additional guide plates are pushed into prepared positions within the second subassembly, as well as fitted in their final installation positions with the aid of pins. This allows a significant reduction of the labor input, which would otherwise be associated with such a retrofitting process.

According to the characteristics of claim 2, the chute assembly is also divided into two subassemblies, wherein the first of these two subassemblies is designed for being fixed on a machine frame and the second subassembly is designed for being easily exchanged in the event of a conversion, for example, from a double-mould operation to a triple-mould operation or vice versa. The first subassembly once again provides a defined installation position, which is configured in accordance with the sliding paths for molten glass gobs to be realized, whereas the second subassembly has the function of forming the direct connecting link for the troughs to be carried.

The characteristics of claims 3 and 4 concern the further design of the aforementioned first subassemblies. It is essential that these first subassemblies feature a defined interface for being connected to the aforementioned second subassemblies, wherein said interface is characterized by insertion positions or plug-in positions or other installation positions, which are adapted to the realization of the different standards of a single-gob, double-gob, triple-gob or multi-gob operation and designed such that the effort associated with this type of retrofitting work can be minimized in comparison with the initially cited prior art.

The characteristics of claims 5 and 6 concern a design of the second subassembly of the guide plate assembly. This second subassembly accordingly consists of a guide plate unit, which can be unitarily handled in order to retrofit the glass forming machine and in the simplest case consists of two lateral carrying sections designed as carriers of the guide plates. This guide plate unit can be equipped with a different number of guide plates in accordance with the realization, for example, of a double-mould operation or triple-mould operation, but a standardized interface for the connection to the first of the two subassemblies of the guide plate assembly is always provided.

The characteristics of claims 7 and 8 concern another constructive design of the two subassemblies of the guide plate assembly. These respectively consist of lateral carrying sections that are connected by means of connecting plates or end plates on their facing sides such that an interface between both subassemblies is respectively formed, wherein the installation position of both subassemblies on one another is secured, for example, by means of a threaded joint. The carrying sections of the second subassembly simultaneously form carriers of the guide plates arranged thereon, wherein a mounting side of the carrying sections is preferably arranged underneath a cover plate and thereby protected from environmental influences.

The characteristics of claims 9 and 10 concern the design of the two subassemblies of the chute assembly. The first of these two subassemblies is provided with extension arms that extend perpendicular to a console and are equipped with standardized installation points, particularly plug-in positions or other installation positions for receiving and fixing the second subassemblies, which are respectively realized in the form of column-like carrying elements. The installation points may be configured in accordance with standardized dimensions of a single-gob, double-gob, triple-gob or multi-gob operation.

The characteristics of claim 11 provide the advantage that a transfer elevation at the transition from the scoop gutter to the guide plate or at the transition from the scoop gutter to a trough can be adjusted. In this way, length adaptations by installing intermediate rings toward the gob distributor are eliminated. The thusly adjusted transfer elevation ultimately can be adapted to special situations of a gob drop on the side of the trough. However, the associated change of the vertical position relative to lower parts of the gutter system such as troughs and chutes is comparatively inconsequential.

According to the characteristics of claims 12 and 13, these carrying elements are configured for realizing a height adjustment of the installation points, wherein two installation points are respectively arranged on top of one another with clearance on a carrying element. The design of a lifting spindle drive used for this height adjustment is generally known and therefore not described in greater detail at this point.

The height adjustment of the aforementioned installation points may be configured manually. According to the characteristics of claim 14, it is particularly advantageous to realize this height adjustment in a motor-driven fashion, particularly with an electric drive. In this case, each of the carrying elements is equipped with such a drive, wherein these drives can preferably be controlled independently of one another.

The characteristics of claims 15 and 16 concern the further design of the electromotive height adjustability of the chutes. The height of these chutes accordingly can be adjusted simultaneously or individually, i.e. independently of one another. In this context, a system of position transmitters may be provided. An adjustable height of the chutes is required, in particular, if no troughs are arranged between the chutes and the guide plates.

According to the characteristics of claim 17, a horizontal adjusting device is assigned to each of the pairs of installation points. This adjusting device allows an adjustment in a horizontal plane and may be configured for a manual actuation. However, an electromotive drive may basically also be considered for this adjustment. These adjusting devices can be advantageously realized in the form of modular subassemblies, which are on one end functionally connected to a vertically extending rail that is connected to the console of the chute assembly and on their other end functionally connected to one of the aforementioned installation points. The mechanical principle, on which these adjusting devices are based, is generally known and not described in greater detail at this point.

The constructive design of the aforementioned installation points may basically be configured arbitrarily. According to the characteristics of claim 18, however, it is particularly advantageous to realize these installation points in the form of slip-on mandrels that cooperate with corresponding elements arranged on the chutes. In this way, a simple installation and removal of the chutes are achieved.

The characteristics of claims 19 and 20 concern the further design of the height adjusting drives. These drives are respectively realized in the form of servomotors that are connected to a control unit. This control unit can be accommodated at a suitable location and allows a simple, centralized control and height adjustment of the installation points or slip-on mandrels, for example, by individually controlling all servomotors. For example, the servomotors are assigned to the aforementioned installation points in the form of subassemblies that can be easily installed and removed and may respectively form part of the aforementioned first subassembly of the chute assembly. A covering is assigned to the drives as protection against any type of environmental influences.

According to the characteristics of claim 21, the guide plates of the guide plate unit may be realized in the form of hollow structures that serve for conveying a coolant. This hollow structure may be realized in the form of an extensive network consisting of conduit elements designed for conveying the coolant, e.g. water, and cover the majority of the guide plate components that come in contact with the molten glass. However, this type of cooling is not limited to the guide plates, but may basically be realized on all components that come in contact with the glass gob and require cooling. Excessive heating of the guide plates or other components of the gutter system, which particularly occurs when processing heavy glass gobs and may impair the gob movement, can be prevented by cooling the sliding paths in this fashion.

According to the characteristics of claims 22, 23, the control unit is configured for adjusting the height of the chutes in accordance with stored values, if applicable in connection with a memory function. Although this requires a system with position transmitters and a corresponding database—an automated displacement to the corresponding vertical positions is thereby also achieved.

The object of the application was described above in connection with gutter systems consisting of a guide plate assembly and a chute assembly. However, it may also be applied analogously to gutter systems that are additionally equipped with troughs between the guide plates and the chutes.

According to the preceding explanations, the inventive gutter system is particularly designed for realizing a fast and cost-effective conversion between a single-mould operation, a double-mould operation, a triple-mould operation or another multi-mould operation and vise versa. This is achieved in that a guide plate assembly and, if applicable, a trough assembly are respectively divided into first and second subassemblies, wherein the first subassemblies remain in their respective installation position on the machine frame in the event of a conversion and only the second subassemblies, which are designed in the form of direct carriers of guide plates or troughs, are exchanged. Standardized interfaces are provided between the respective first and second subassemblies and significantly reduce the otherwise required configuration or adjustment activities due to defined insertion positions, plug-in positions or the like.

An exemplary embodiment of the invention is described in greater detail below with reference to the attached drawings. In these drawings:

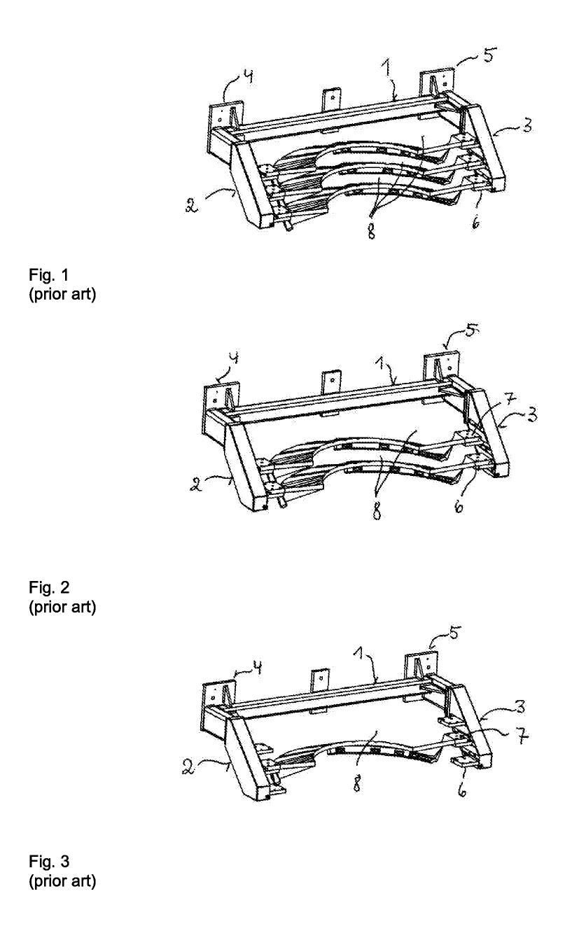

FIG. 1 shows a perspective representation of a guide plate assembly for a double-gob operation according to the prior art;

FIG. 2 shows a perspective representation of a guide plate assembly for a triple-gob operation according to the prior art;

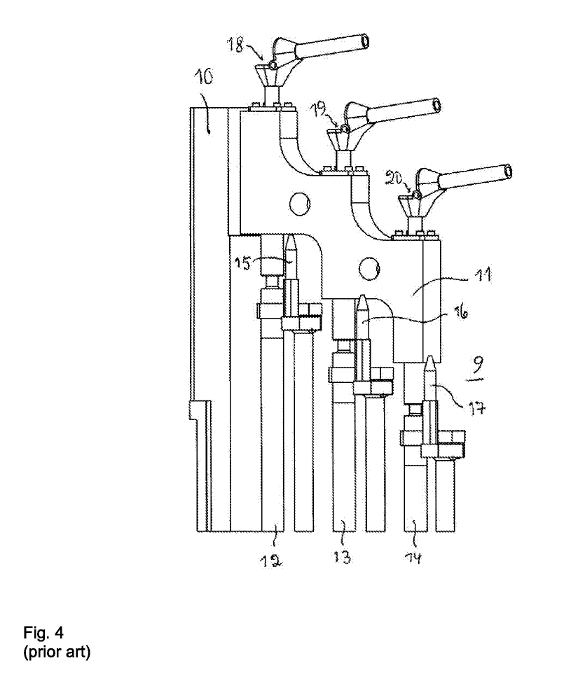

FIG. 3 shows a perspective representation of a guide plate assembly for a single-gob operation according to the prior art;

FIG. 4 shows a partial side view of a chute height adjustment according to the prior art;

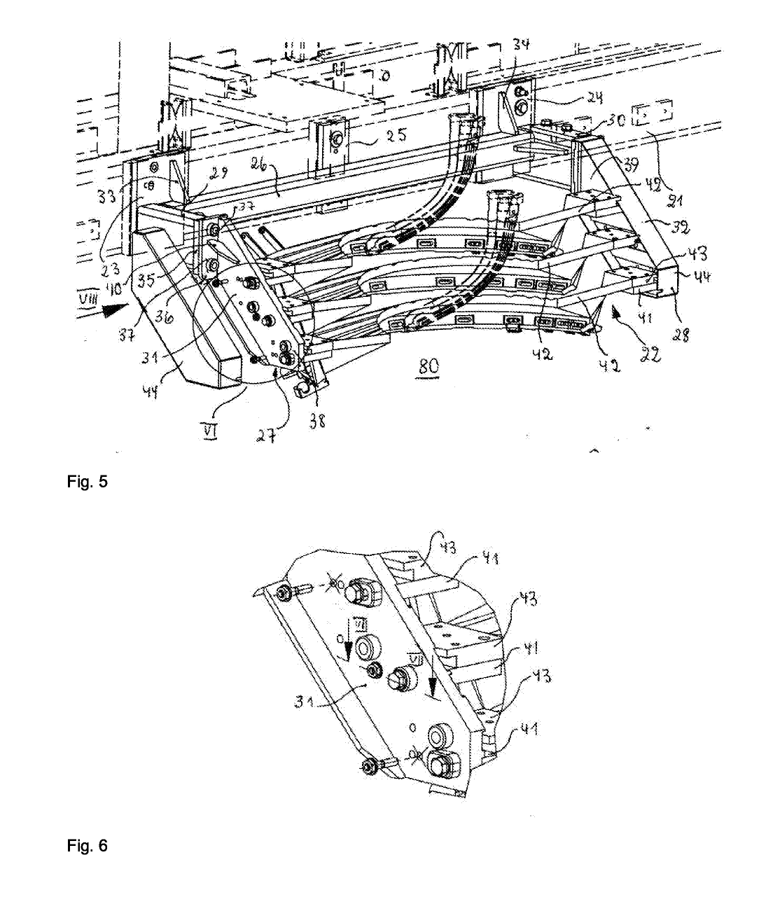

FIG. 5 shows a perspective representation of an inventive guide plate assembly for a triple-gob operation in the installed state;

FIG. 6 shows an enlarged representation of a detail VI of FIG. 5;

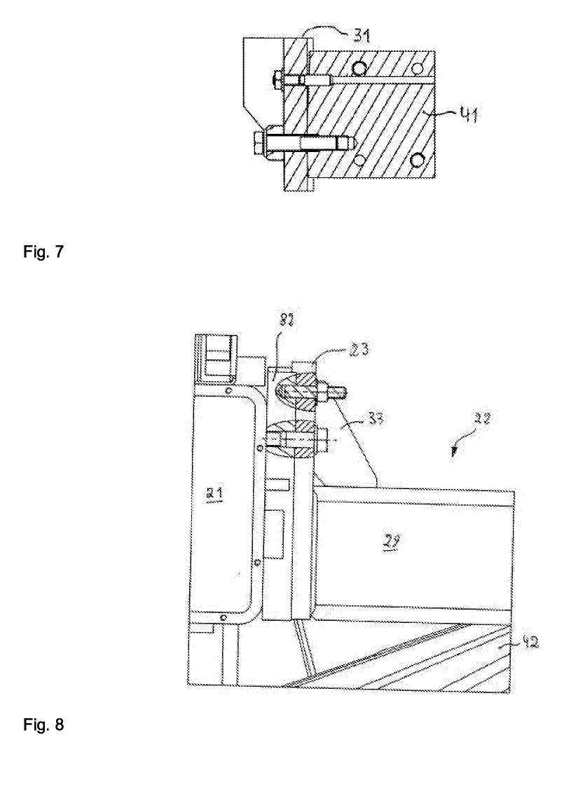

FIG. 7 shows a partial horizontal section through the detail according to FIG. 6 along the line VII-VII;

FIG. 8 shows an enlarged partial side view corresponding to a viewing direction VIII in FIG. 5;

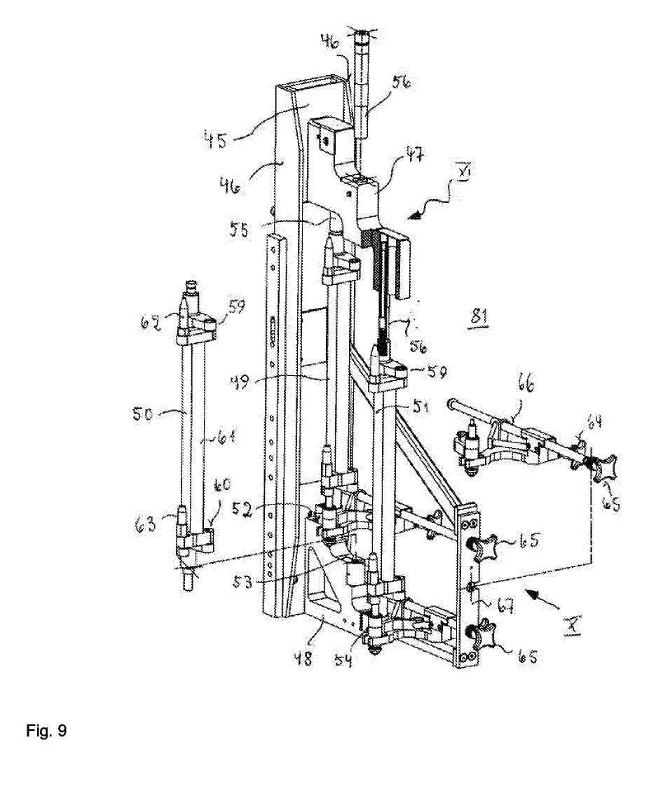

FIG. 9 shows a perspective representation of an inventive chute adjustment;

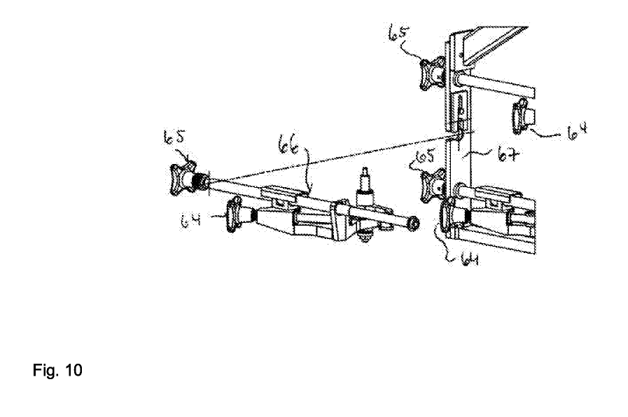

FIG. 10 shows a partial representation of an enlarged detail X of FIG. 9;

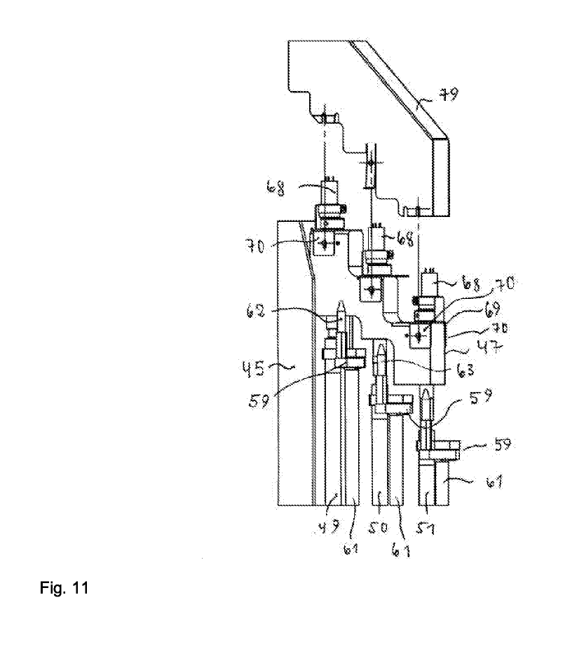

FIG. 11 shows an enlarged partial representation of the upper part XI of FIG. 9;

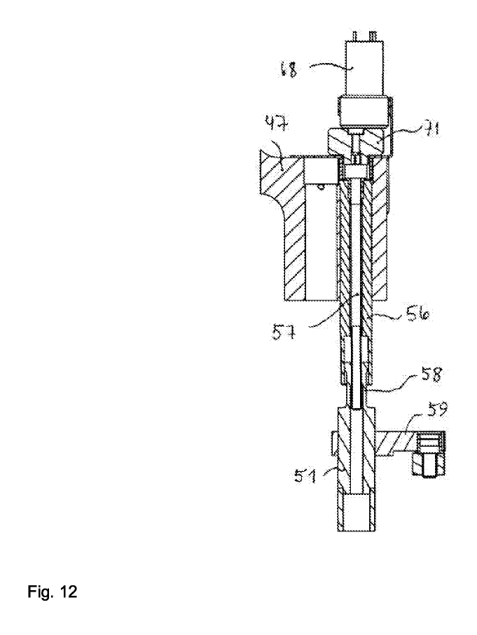

FIG. 12 shows an enlarged partial representation of the drive for the inventive chute adjustment in the form of an axial section; and

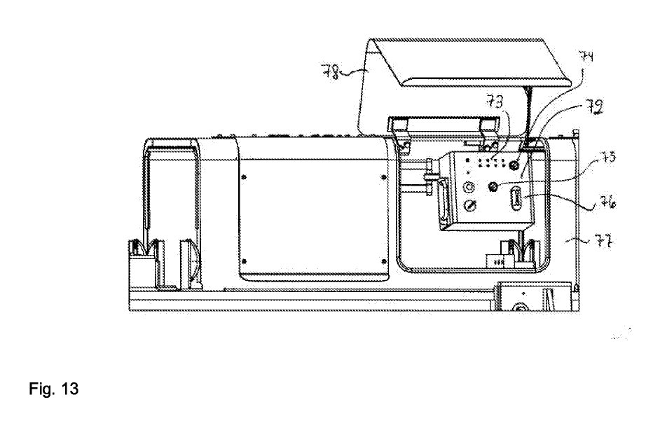

FIG. 13 shows a schematic representation of an inventive control of the chute height adjustment.

In order to elucidate the prior art, the description initially refers to FIGS. 1-5, wherein the conventional design of an assembly intended for supporting guide plates is described as part of the gutter system of an IS machine with reference to FIGS. 1-3. These assemblies respectively consist of a base 1, on the two ends of which carrying arms 2, 3 are arranged, wherein the base 1 is designed for being mounted on a not-shown scoop beam and therefore on the machine frame of a glass forming machine by means of mounting plates 4, 5, which are likewise arranged on its ends.

The carrying arms 2, 3 extend in parallel planes perpendicular to the longitudinal extent of the base 1 and are provided with holding plates 6 on their facing sides, wherein guide plates 8 are respectively supported on said holding plates by means of intermediately arranged mounting pieces 7. Depending on the utilization of the assembly for a single-mould, double-mould or triple-mould operation, one (FIG. 3), two (FIG. 2) or three (FIG. 1) guide plates 8 are arranged on top of one another on the carrying arms 2, 3 such that they are offset in the direction toward the base 1.

During the operation of this assembly, gobs separated from a strand of molten glass are successively delivered to the different gutters of the guide plate/guide plates by means of a scoop gutter, which is pivotable about a vertical axis, in dependence on the pivoting position of the scoop gutter, wherein said gobs are then fed to a mould, particularly a blank mould, in which the actual forming process begins, by means of downstream gutter elements that are respectively formed by a trough and an adjacent chute.

The gutters of the guide plate practically consist of recesses that are milled into their casting and designed for realizing a gutter-like guide function for the aforementioned gob.

In order to achieve an optimal gob movement and a readily reproducible gob shape, it is very important to realize a defined sliding path of the gobs during the transfer from the scoop gutter into the aforementioned blank mould via the gutters or recesses of the guide plate, the trough and the chute. In this context, it is particularly required to adjust a certain angle of impact of the gob that exits the scoop gutter and impacts on the gutter of the guide plate. This applies analogously to the transfer from the gutter of the guide plate to the trough and from the trough to the chute. This is achieved by adjusting a respective superelevation, namely of the respective lower end of a guide element relative to the upper end of the guide element arranged adjacent thereto in the downward direction of the sliding path. The position of the trough relative to the guide plate, as well as the position of the trough relative to the chute, which is held on the machine frame, but equipped, among other things, with a vertical adjustment, is likewise configured in an adjustable fashion.

FIG. 4 shows part of an adjusting unit 9 for the vertical adjustment of the chutes for a triple-mould operation, wherein said adjusting unit is configured on a console 10 in order to be mounted on a machine frame. The adjusting unit 9 is characterized by an extension arm 11, wherein three double columns 12, 13, 14, which extend vertically and parallel to one another and to the console, are supported in said extension arm and their lifting motion can be transferred to the vertical position of three slip-on mandrels 15, 16, 17, on which the chutes are supported. The columns 12, 13, 14 can be manually driven by means of respective angular gears 18, 19, 20 connected to their upper ends in order to adjust the vertical position of the slip-on the mandrels 15, 16, 17. In this case, only the three upper slip-on mandrels 15, 16, 17 are illustrated in FIG. 4. However, each trough is actually held by means of two slip-on mandrels that are arranged on top of one another with vertical spacing, but the respective lower slip-on mandrels are not illustrated in order to provide a better overview.

In the event of a conversion from a single-gob operation to a double or triple-gob operation or vice versa, the complete unit consisting of the base 1 and the carrying arms 2, 3 needs to be removed and replaced with a different unit in these above-described embodiments of a gutter system. This applies analogously to the adjusting unit 9, which also has to be replaced in this case together with the console 10 carrying the adjusting unit. Both assemblies, namely the guide plate assembly consisting of the base, the carrying arms and the supported guide plates, as well as the aforementioned adjusting unit, can only be handled unitarily and accordingly have to be removed and installed in the form of assemblies. This is respectively associated, among other things, with extensive alignments of the base 1 and of the console 10 in both instances.

The following portion of the description refers to the illustrations in FIGS. 5-8 in order to elucidate an inventive guide plate assembly 80 as part of an inventive gutter system.

The reference symbol 21 in FIG. 5 identifies a scoop beam that is drawn with broken lines, wherein this scoop beam is intended as carrier of a guide plate assembly 80 and said assembly is held thereon by means of two mounting plates 23, 24. The reference symbol 25 identifies a centering plate that is connected to a horizontally extending base 26 in the same fashion as the mounting plates 23, 24 and arranged centrally relative to said base. The centering plate 25 conventionally serves for centrally mounting the base 26 on the scoop beam 21 in a defined, construction-related installation position in connection with a fixed marking on the machine.

The guide plate assembly 80 is arranged on the scoop beam 21 in a vertically adjustable fashion, namely by means of a correspondingly adjustable mounting of the mounting plates 23, 24 on the scoop beam. This can be constructively realized, for example, by means of two threaded pins that can be forced apart and are arranged on an edge of the scoop beam 21. The horizontal alignment of the guide plate assembly 80 with a gob distributor is preserved by means of a vertical groove in the centering plate 25, in which pins are accommodated in a sliding fashion.

Carrying arms 27, 28 extend from both ends of the base 26 in parallel vertical planes and respectively consist of a first, horizontally extending carrying section 29, 30 that is directly attached to the corresponding end face of the base 26 and a second carrying section 31, 32 that extends from the first carrying section such that it is inclined in the direction extending away from the base 26. The mounting plates 23, 24 are directly coupled to base plates 22 that in turn are directly mounted on the scoop beam 21. These mounting plates make it possible to realize a defined installation position.

The reference symbols 33, 34 identify triangular reinforcing plates that are statically active between the mounting plates 23, 24 and the facing upper sides of the base 26.

The ends of the carrying sections 29, 30 facing away from the base 26 are realized in the form of end plates 35 that extend vertically and parallel to the base 26, wherein connecting plates 36 are respectively screwed to said end plates with the aid of two screws 37.

The connecting plates 36 extending parallel to the end plates 35 respectively form parts of the second carrying section 31, 32 and are connected to holding arms 38, 39, which extend in vertical planes and parallel to one another, on their side facing away from the end plates 35, wherein triangular reinforcing plates 40 are statically active between the connecting plates 36 and at least one facing side of a holding arm.

The guide plate unit 22 is designed for a triple-mould operation and a generally known arrangement of six holding plates 41 is accordingly located on the facing sides of the carrying arms 27, 28, namely of the holding arms 38, 39, wherein the mounting pieces 43 arranged laterally on the three guide plates 43 are supported and conventionally mounted on said holding plates in order to fix the guide plates 42.

The reference symbol 44 identifies cover plates for covering, in particular, the sides of the holding arms 38, 39 that face away from the guide plates 42 and in this case serve for producing screw joints, among other things with the holding plates 41, as illustrated in FIG. 7.

In such a guide plate assembly 80, a first subassembly, which is directly connected to the machine frame, is formed by the base 26, as well as the carrying sections 31, 32 laterally attached thereto, and a second, easily replaceable subassembly is formed by the guide plate unit 22 and defined as direct carrier of the guide plates 42.

The following portion of the description refers to the illustrations in FIGS. 9-12 in order to respectively elucidate an inventive chute assembly or a horizontal chute adjustment 81 as part of an inventive gutter system.

These figures show an elongated console that is realized in the form of a hollow box construction and intended and designed for being vertically mounted on the machine frame of an IS machine, particularly on a horizontal supporting structure. The console 45 has an essentially rectangular cross section and is equipped with lateral reinforcing plates 46 that lie opposite of one another.

An upper extension arm 47 and a lower extension arm 48 are mounted on the console 45 and extend away from the console in a common vertical plane.

Three parallel, column-like carrying elements 49, 50, 51 are supported between the extension arms 47, 48, namely in receptacles 52, 53 and 54 of the lower extension arm 48, as well as in the upper extension arm 47 by means of intermediately arranged shafts 55, 56.

The shafts 55, 56 are realized in the form of hollow shafts and respectively serve for accommodating a lifting spindle 57, the drive of which is described in greater detail below. On their lower ends, they are connected to the facing ends of the carrying elements 49, 50, 51 that are respectively realized in the form of threaded couplings 58 featuring an internal thread, with which the lifting spindle 57 is engaged.

Each of the carrying elements 49, 50, 51 is provided with two spaced-apart supporting elements 59, 60 that are connected to one another by means of a rod 61 and respectively configured as carriers of slip-on mandrels 62, 63. These slip-on mandrels 62, 63 are intended for cooperating with corresponding counter elements of a chute, which are generally known and therefore not described in greater detail at this point.

In this respect, it is essential that the installation positions of the carrying elements 49, 50, 51 are realized in the form of plug-in positions that allow a simple and fast installation and removal.

Adjusting devices 66 are respectively assigned to each of the lower receptacles 52, 53, 54 and actuated manually with the aid of handwheels 64, 65, wherein these adjusting devices make it possible to adjust the installation position of the slip-on mandrels 62, 63 and therefore of the chute carried thereby in a horizontal plane. The adjusting devices 66 are mounted in a vertical rail 67 that is rigidly connected to the console 45 on its lower and upper ends. The mechanical function of these adjusting devices, the adjusting motion of which acts in a horizontal plane and can be transmitted to the lower ends of the rods and therefore to the slip-on mandrels 62, 63, is generally known and not described in greater detail at this point.

In such a chute assembly 81 or horizontal chute adjustment, its first subassembly intended for being directly mounted on the machine frame is formed by the console 45 and the two extension arms 47, 48 whereas the second, easily replaceable subassemblies intended as carriers of a chute are formed by the carrying elements 49, 50, 41.

The drive for the adjusting motion in a vertical direction acts upon the lifting spindle 57 and is preferably realized in the form of a geared motor 68 that is arranged on the extension arm 47 coaxially to the lifting spindle 57. The geared motor or servomotor 68 is accommodated in a carrier unit 69 that laterally encompasses the extension arm 47 on both sides by means of mounting plates 70 laterally formed thereon and is screwed to said extension arm. A handwheel 71 provided with a knurling is likewise accommodated in the carrier unit 69 and connected to the lifting spindle 57 in order to also allow a manually generated adjusting motion as needed. The thusly designed drive is connected to the lifting spindle 57 by means of a plug-in coupling such that a simple removal and installation can also be realized as needed in this case.

All geared motors 69 are functionally connected to a control unit 72 that is advantageously arranged in the vicinity of a gob distributor of the glass forming machine and equipped with an optical display 73 such as, e.g., an LED matrix for displaying the position selected by means of two rotary knobs 74, 75, namely the position of the respective trough, in a visually perceivable fashion, as well as with the switch 76 for initiating a downward or upward motion.

For example, the control unit 72 is accommodated within a housing 77, which can be closed with a hinged cover 78, in the vicinity of a gob distributor of the IS machine and thereby protected from environmental influences.

The reference symbol 79 identifies a covering that is intended for being fitted on the upper sides of the extension arms 47 such that the geared motors 68 are arranged in a protected fashion.

Another potential embodiment of the gutter system concerns the equipment of the guide plates 42 with an integrated cooling system that is realized analogous to the cooling system already known from the scoop gutters and operates, for example, with water or a different coolant. This measure prevents excessive heating of the guide plates, for example when processing heavy gobs, and altogether improves the gob movement.

It is easy to recognize that a gutter system characterized by an above-described horizontal chute assembly 81, as well as an inventive guide plate assembly 80, makes it possible to easily convert, for example, from a single-gob operation to a double-gob or a triple-gob operation and vice versa as needed insofar as these two components are concerned.

With respect to the guide plate assembly 80, this is possible because its first subassembly, namely the base 26 and the first carrying sections 29, 30 directly attached thereto, can remain on the machine frame during such a conversion and a replacement is limited to its second subassembly consisting of the aforementioned second carrying sections 31, 32, on which the guide plates 42 are arranged. If applicable, the replacement of only parts of the second subassembly may also be considered.

With respect to the horizontal chute assembly 81, this is possible because its first subassembly, namely the console 45 and the extension arms 47, 48, can remain on the machine frame and a replacement is limited to its second subassemblies, namely the carrying elements 49, 50, 51. The extension arms 47, 48 are provided with plug-in positions designed for accommodating the carrying elements 49, 50, 51. An additional simplification can be achieved by realizing an electric height adjustment of the chutes.

In both instances, configuration or adjustment activities associated with the attachment of the aforementioned base or console on the machine frame of the IS machine are therefore eliminated.

### LIST OF REFERENCE SYMBOLS

1 Base
2 Carrying arm
3 Carrying arm
4 Mounting plate
5 Mounting plate
6 Holding plate
7 Mounting piece
8 Guide plate
9 Adjusting unit
10 Console
11 Extension arm
12 Column
13 Column
14 Column
15 Slip-on mandrel
16 Slip-on mandrel
17 Slip-on mandrel
18 Angular gear
19 Angular gear
20 Angular gear
21 Scoop beam
22 Guide plate unit
23 Mounting plate
24 Mounting plate
25 Centering plate
26 Base
27 Carrying arm
28 Carrying arm
29 Carrying section
30 Carrying section
31 Carrying section
32 Carrying section
33 Reinforcing plate
34 Reinforcing plate
35 End plate
36 Connecting plate
37 Screw
38 Holding arm
39 Holding arm
40 Reinforcing plate
41 Holding plate
42 Guide plate
43 Mounting piece
44 Cover plate
45 Console
46 Reinforcing plate
47 Extension arm
48 Extension arm
49 Carrying element
50 Carrying element
51 Carrying element
52 Receptacle
53 Receptacle
54 Receptacle
55 Shaft
56 Shaft
57 Lifting spindle
58 Threaded coupling
59 Supporting element
60 Supporting element
61 Rod
62 Slip-on mandrel
63 Slip-on mandrel
64 Handwheel
65 Handwheel
66 Adjusting device
67 Rail
68 Servomotor
69 Carrier unit
70 Mounting plate
71 Handwheel
72 Control unit
73 Display
74 Rotary knob
75 Rotary knob
76 Switch
77 Housing
78 Cover
79 Covering
80 Guide plate assembly
81 Chute assembly
82 Base plate

1-23. (canceled)

24. A gutter system for a glass forming machine, particularly an IS machine, with sliding paths for molten glass gobs extending from a scoop gutter, which can be pivoted about a vertical axis, into a blank mould via at least one guide plate assembly (80) and one chute assembly (81), wherein the guide plate assembly (80) consists of at least one guide plate (42) that features multiple gutters intended for respectively guiding one glass gob, wherein the chute assembly (81) consists of at least one chute, wherein the guide plate assembly (80) and the chute assembly (81) are mounted on the machine frame of the IS machine, and wherein the guide plate assembly (80) and the chute assembly (81) respectively consist of a first subassembly, which is directly mounted on the machine frame, and a second subassembly designed as a direct carrier of the guide plate (42) or the chute, characterized in that the first subassemblies are provided with a standardized interface designed for connecting the second subassemblies, in that the second subassemblies are realized in the form of easily replaceable subassemblies, which are respectively provided with an interface for the connection to the first subassembly and intended and designed for a conversion from a single-mould or double-mould operation to a triple-mould or multi-mould operation and vice versa, and in that the second subassembly of the guide plate assembly (80) consists of a guide plate unit (22), which is replaceably mounted on the first subassembly of the guide plate assembly (80) and consists of two lateral carrying sections (31, 32), between which at least one guide plate (42) is held.

25. The gutter system according to claim 24, characterized in that the first subassembly of the guide plate assembly (80) consists of at least one base (26) that is mounted on a scoop beam (21).

26. The gutter system according to claim 24, characterized in that the first subassembly of the chute assembly (81) consists of at least one console (45) that is mounted on the machine frame, wherein at least two extension arms (47, 48), which extend essentially perpendicular to said console and are configured for mounting the second subassembly of the chute assembly (81), are arranged on top of one another with clearance on the console (45).

27. The gutter system according to claim 24, characterized in that the carrying sections (31, 32) are provided with connecting plates (36) on their ends that face the base (26), in that carrying sections (29, 30), which extend perpendicular to the base (26) and lie opposite of the carrying sections (31, 32) in the installed state, are arranged on the base, in that the carrying sections (29, 30) are provided with end plates (35) on their ends that face away from the base (26), and in that a simple separable connection between the second subassembly of the guide plate assembly (80) in the form of the guide plate unit (22) and its first subassembly formed by the base (26) and the carrying sections (29, 30) is realized in the form of a screw joint between the connecting plates (36) and the end plates (75).

28. The gutter system according to claim 24, characterized in that at least the mounting side of the two carrying sections (31, 32) of the guide plate unit (22) is protected with cover plates (44).

29. The gutter system according to claim 24, characterized in that the second subassembly of the chute assembly (81) consists of at least one column-like carrying element (49, 50, 51) that can be inserted and fixed in defined positions between the two extension arms (47, 48) of the first subassembly of the chute assembly (81).

30. The gutter system according to claim 29, characterized in that the aforementioned positions of the extension arms (47, 48) are configured in the form of plug-in positions that are arranged in accordance with the realization of a double-mould, triple-mould or multi-mould operation.

31. The gutter system according to claim 24, characterized in that the guide plate assembly (80) is arranged on the machine frame of the IS machine such that its height can be adjusted.

32. The gutter system according to claim 6, characterized in that the carrying elements (49, 50, 51) are designed for being connected to the chutes, particularly for realizing two installation points for a chute that are arranged on top of one another.

33. The gutter system according to claim 9, characterized in that the installation points are configured for realizing a height adjustment of the position of the respective chute.

34. The gutter system according to claim 26, characterized in that the upper of the two vertical extension arms (47, 48) is configured as a carrier of an electromotive drive for the height adjustment of each of the multiple chutes.

35. The gutter system according to claim 34, characterized in that all chutes are configured for a simultaneous electromotive height adjustment.

36. The gutter system according to claim 34, characterized in that all chutes are configured for individual electromotive height adjustments.

37. The gutter system according to claim 32, characterized by a rail (67) that extends parallel to the console (45) and is mounted thereon, wherein one end of a horizontal adjusting device (66) is respectively accommodated in said rail and its other end is functionally connected to one of the aforementioned installation points.

38. The gutter system according to claim 32, characterized in that the installation points are realized in the form of slip-on mandrels (62, 63) designed for attaching corresponding elements connected to the respective chute.

39. The gutter system according to claim 35, characterized in that a control unit (72) is assigned to the motor drives realized in the form of servomotors (68).

40. The gutter system according to claim 35, characterized in that a covering (79) is assigned to the motor drives.

41. The gutter system according to claim 24, characterized in that the guide plates (42) of the guide plate unit (22) are respectively realized in the form of a hollow structure designed for conveying a coolant.

42. The gutter system according to claim 41, characterized in that the height of the chute/chutes can be adjusted with the cooperation of the control unit (72) in accordance with stored values.

43. The gutter system according to claim 39, characterized in that the height of the chute/chutes can be adjusted with the cooperation of the control unit (72) by means of a storage system comprising a memory function.
